(19) United States
(12) Patent Application Publication
(10) Pub. No.: US 2024/0381233 A1
(43) Pub. Date: Nov. 14, 2024

(54) NETWORK THROUGHPUT

(71) Applicant: Cisco Technology, Inc., San Jose, CA (US)

(72) Inventors: Indermeet S. Gandhi, San Jose, CA (US); Brian D. Hart, Sunnyvale, CA (US); Jerome Henry, Pittsboro, NC (US); Shailender Potharaju, Fremont, CA (US)

(73) Assignee: Cisco Technology, Inc., San Jose, CA (US)

(21) Appl. No.: 18/541,052

(22) Filed: Dec. 15, 2023

Related U.S. Application Data
(60) Provisional application No. 63/502,089, filed on May 13, 2023.

(51) Int. Cl. H04W 48/16; H04W 28/02

(52) U.S. Cl. CPC H04W 48/16; H04W 28/0215

(57) ABSTRACT

Improving network throughput and, specifically, improving network throughput for networks comprising sub-7.25 GHz and millimeter wave links may be provided. Improving network throughput may include determining device information of a Station (STA). The STA may be enabled to communicate on a 60 (GHz) band in addition to sub 7.25 GHz bands based on the device information.

### RELATED APPLICATION

Under provisions of 35 U.S.C. § 119 (e), Applicant claims benefit of U.S. Provisional Application No. 63/502,089, filed May 13, 2023, which is incorporated herein by reference.

### TECHNICAL FIELD

The present disclosure relates generally to improving network throughput and, specifically, improving network throughput for networks comprising sub-7.25 GHZ and millimeter wave links.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for improving network throughput;

FIG. 2 is a flow chart of a method for improving network throughput; and

FIG. 3 is a block diagram of a computing device.

### DETAILED DESCRIPTION

### Overview

Improving network throughput and, specifically, improving network throughput for networks comprising sub-7.25 GHz and millimeter wave links may be provided. Improving network throughput may include determining device information of a Station (STA). The STA may be enabled to communicate on a 60 (GHz) band in addition to sub 7.25 GHz bands based on the device information.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Some devices and/or device uses (e.g., immersive metaverse, extended reality, Virtual Reality (VR), Augmented Reality (AR)) may require a network to enable operations in the sub 7.25 Gigahertz (GHz) spectrum (e.g., the 2.4 Ghz, 5 GHZ, and 6 GHz bands) and the millimeter wave band of operation. The unlicensed spectrum in the millimeter band may include the spectrum between forty GHz and eighty GHz. The unlicensed spectrum in the millimeter band may be referred to as the 60 GHz band herein, the typical label for the allocation. The 60 GHz band may allow high throughput communication required for extended reality types of applications.

While the 60 GHz band offers a wide spectrum for contention-free, high throughput operation, the 60 GHz band may have high penetration loss and scattering may occur in the presence of obstacles. Thus, operations in the 60 GHz band may be limited to Line-of-Sight operation and, potentially, single reflection operation. Additionally, devices performing operations using the 60 GHz band frequencies and data rates may overheat and/or experience battery drain.

Multi-Link Operation (MLO) may enable Stations (STAs) to connect on more than one link with an Access Point (AP). Therefore, methods for addressing the limitations of using the 60 Ghz band are described herein by selectively enabling transmissions on the 60 GHz band using MLO.

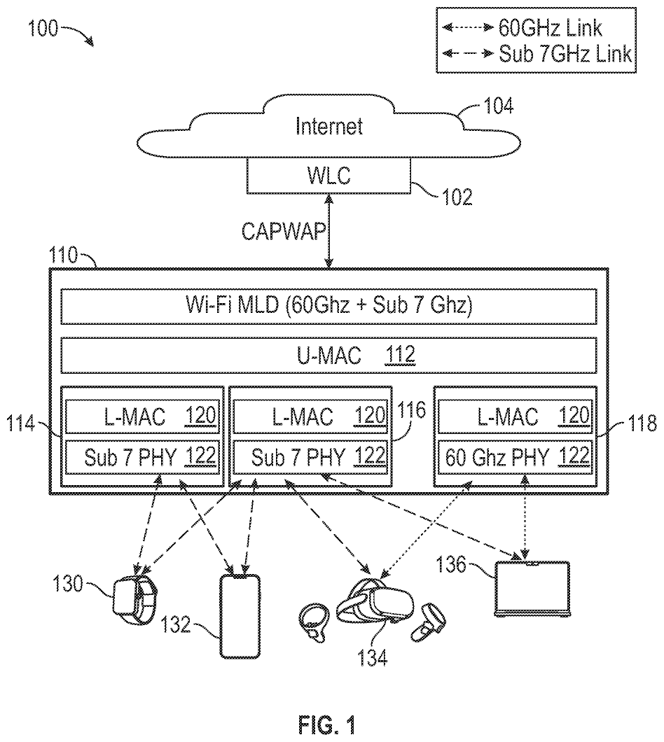

FIG. 1 is a block diagram of an operating environment 100 for improving network throughput. The operating environment 100 may include a controller 102, the internet 104, an AP 110, a first STA 130, a second STA 132, a third STA 134, and a fourth STA 136. The controller 102 may be a network controller (e.g., a Wireless Local Area Network (WLAN controller) that controls the operation of the network and the devices of the network, such as the AP 110. The AP 110 may enable other devices to connect to the network (e.g., to access the internet 104).

The first STA 130, the second STA 132, the third STA 134, and the fourth STA 136 may be any device that may connect to the network via the AP 110, such as a smartphone, a laptop, a tablet, a server, a personal computer, etc. Not all STAs may support communications over the 60 GHz band. For example, only the third STA 134 and the fourth STA 136 may support communications over the 60 GHz band in the operating environment 100. Thus, the first STA 130 and the second STA 132 may connect to or otherwise communicate with the AP 110 via the first AP STA 114 and/or the second AP STA 116, and the third STA 134 and the fourth STA 136 may connect to or otherwise communicate with the AP 110 via the first AP STA 114, the second AP STA 116, and/or the third AP STA 118.

The AP 110 may be a Multi-Link Device (MLD) that enables the first STA 130, the second STA 132, the third STA 134, and the fourth STA 136 to communicate to the AP 110, and therefore the network, via the sub 7.25 GHz bands and the 60 GHz band. The AP 110 may include an Upper Medium Access Control (MAC) (U-MAC) 112, a first AP STA 114, a second AP STA 116, and a third AP STA 118. The first AP STA 114, the second AP STA 116, and the third AP STA 118 may include Lower MACs (L-MAC) 120 and Physical Layers (PHY) 122.

The U-MAC 112 may perform link agnostic operations, such as sequence number assignation, aggregating the first AP STA 114, a second AP STA 116, and a third AP STA 118, and providing logical link control. The L-MACs 120 may control link specific functionalities for the first AP STA 114, the second AP STA 116, and the third AP STA 118, such as channel access. The PHYs 122 may be electronic circuits that implement physical layer functions. For example, the PHYs 122 may connect the L-MACs 120 to a physical medium for operation.

The first AP STA 114 and the second AP STA 116 may be sub-7.25 GHZ STAs, enabling channel access via the 2.4 Ghz band, the 5 GHz band, or the 6 GHz band. The first AP STA 114 and the second AP STA 116 may use different bands to provide channel access via multiple bands. The third AP STA 118 may be a 60 GHz STA, enabling channel access via the 60 GHz band. There may be a different number of 7.25 GHZ AP STAs and 60 GHZ AP STAs in other examples. Therefore, the AP 110 may support communications in the 2.4 Ghz band, the 5 GHz band, the 6 GHz band, and the 60 GHz band.

The AP 110 may advertise the capabilities of the 60 GHz link (e.g., via the third AP STA 118) and/or the channel availability. For example, the AP 110 may advertise the 60 GHz link capabilities and/or channel availability using beacons transmitted on the 2.4 GHZ, 5 GHZ, and/or 6 GHz bands (e.g., via the first AP STA 114 and/or the second AP STA 116), notifying the first STA 130, the second STA 132, the third STA 134, and the fourth STA 136 that the AP 110 includes 60 GHz capable STAs (i.e., the third AP STA 118).

The first STA 130, the second STA 132, the third STA 134, and the fourth STA 136 may associate with the AP 110 via any link, but may typically associate using 2.4 GHZ, 5 GHZ, and/or 6 GHz links provided by the first AP STA 114 and/or the second AP STA 116. During association, all available links to the first STA 130, the second STA 132, the third STA 134, and the fourth STA 136 may be added to the multi-link setup of the AP 110.

When the first STA 130, the second STA 132, the third STA 134, and the fourth STA 136 do not associate using the 60 GHz band, the 60 GHZ AP STA (i.e., the third AP STA 118, may automatically operate in power save mode and may not consume any power or consume minimal power. When the 60 GHZ AP STA needs to operate to communicate with the first STA 130, the second STA 132, the third STA 134, and/or the fourth STA 136, the 60 GHZ AP STA may switch to normal power mode from the power save mode enable communications using the 60 GHz band.

In some examples, the AP 110 can indicate to the first STA 130, the second STA 132, the third STA 134, and/or the fourth STA 136 a preference for communications via 60 GHz band. The AP 110 may indicate the preference for using the 60 GHz band all of a STA's traffic or a specific portion of the STA's traffic. For example, the AP 110 may select the third STA 134 and the fourth STA 136 to use the 60 GHz band and indicate the preference to the third STA 134 and the fourth STA 136. The third STA 134 and the fourth STA 136 may then communicate with the AP 110 over the 60 GHz band via the third AP STA 118.

The AP 110 and the first STA 130, the second STA 132, the third STA 134, and/or the fourth STA 136 may perform Traffic Identifier (TID)-to-Link mapping negotiation so each TID is mapped to one or more agreed links (e.g., via the 2.4 GHz band, via the 5 Ghz band, via the 6 GHz band, or via the 60 GHz band). For instance, the AP 110 may map any traffic that requires or would benefit from being transferred via the 60 GHz band (e.g., traffic associated with immersive metaverse, extended reality, AR, VR) links that utilize the 60 GHz band. The AP 110 may map other traffic to any links except links that utilize the 60 GHz band.

The first STA 130, the second STA 132, the third STA 134, and/or the fourth STA 136 may send messages, such as Advanced Scheduling Requests (ASRs) or Buffer Status Reports (BSRs), to the AP 110 that include a preference for communicating using the 60 GHz band for certain applications, 5-tuples, TIDs, and/or the like. Additionally, the first STA 130, the second STA 132, the third STA 134, and/or the fourth STA 136 can communicate device information, such as the battery level and/or heat level information, in the same message indicating the preference for communications using the 60 GHz band or in a separate message, such as an Action Frame. The STA may send the message with the battery and overheating information to the AP 110 in response to crossing threshold limits (e.g., five percent battery remaining, ten percent battery remaining, five degrees from overheating, ten degrees from overheating, etc.).

The AP 110 may use the device information, such as the battery level and/or heat level information, to determine whether the associated STA should communicate using the 60 GHz band. In some examples, the first STA 130, the second STA 132, the third STA 134, and/or the fourth STA 136 may instead determine whether the device should communicate based on the device information. The first STA 130, the second STA 132, the third STA 134, and/or the fourth STA 136 may communicate to the AP 110 whether the STA disfavors the 60 GHz link when it exceeds locally-known thresholds (e.g., thresholds the STA has stored or otherwise accesses to compare to the current battery level and/or heat level information).

The AP 110 may additionally have the capability to demand or recommend that an STA (e.g., the first STA 130, the second STA 132, the third STA 134, the fourth STA 136) use the 60 GHz band. The AP 110 may transmit an action or control frame with the demand or recommendation in response to receiving a message, such as a ASR, a BSR or an Action Frame, from the STA when the following conditions are met: (i) the application or operation of the STA requires or would otherwise benefit from high bandwidth for short time-period; (ii) the STA's battery level is above a threshold, the battery is currently charging, or the STA is being supplied power from an external source; and (iii) the heat level information indicates the STA is operating at a temperature below a threshold. Thus, the AP 110 may demand or recommend the STA use the 60 GHz band when the STA is capable of using the 60 GHz band.

An STA may also determine to use the 60 GHz band without receiving a demand or recommendation from the AP 110. For example, the STA may determine (i) the application or operation of the STA requires or would otherwise benefit from high bandwidth for short time-period (e.g., the bandwidth is above a bandwidth threshold); (ii) the STA's battery level is above a threshold, the battery is currently charging, or the STA is being supplied power from an external source; and (iii) the heat level information indicates the STA is operating at a temperature below a threshold, and determine to use the 60 GHz band. The STA may notify the AP 110 that the STA determines to use the 60 GHz band, and the AP 110 may enable the STA to use the 60 GHz band.

The AP 110 may also monitor the application (e.g., whether the STA needs high bandwidth) and/or operation of the STA (e.g., battery level information, and/or the heat level information) to determine whether the STA should stop using the 60 GHz band. Because using the 60 GHz band may cause higher levels of battery drain and higher heating levels, the AP 110 may monitor a drain slope of the battery level and a slope of heating levels for the STAs using the 60 GHz band. The battery level slope and heating level slope may vary based on the device type, the number of 60 GHZ Radio Frequency (RF) chains and/or antennas, and/or the like. The AP 110, the controller 102, and/or some other network device may determine battery level and heating level thresholds for each device type. The AP 110 may use the battery level slope and heating level slope to estimate the time a STA can continue to utilize the 60 GHz band. For example, a smart phone may have stricter thresholds (e.g., will be instructed to stop using the 60 GHz band sooner) than a VR headset, because the smartphone may have multiple uses while the VR headset primarily operates to provide access to high bandwidth VR applications that may need to use the 60 GHz band. Enterprise policies can also define the threshold(s) for each of the device type based on the device specifications (e.g., battery discharge rate, heat management capabilities, etc.) and functions (e.g., primarily high bandwidth uses, mixed uses, etc.).

In some embodiments, as a STA's battery level and/or the heat level reach the threshold(s), the AP 110 may prioritize more energy efficient transmissions for the STA. Depending on the STA architecture, as communicated to the AP for example, the AP 110 may initiate more brief, and/or faster communications (e.g., wider bandwidth, more spatial streams), fewer spatial streams, and/or a narrower bandwidth (e.g. a smaller Resource Unit (RU) size). Thus, the STA may continue to use the 60 GHz band while consuming less power. An STA may also have communications policies that causes Downlink (DL) and Uplink (UL) to be more efficient using the 60 GHz band. Thus, the AP 110 may enable UL or DL only using the 60 GHz band to enable the STA to use less power (e.g., the AP 110 causes or instructs the STA to use the 60 GHz band primarily or only for DL and use sub 7.25 GHz bands primarily or only for UL).

In other embodiments, as a STA's battery level and/or the heat level reach the threshold(s), the AP 110 may initiate a deletion of the 60 Ghz link to the STA and inform the STA the reason for the link deletion (e.g., for battery conservation, overheat risk, or the AP 110 received a message from tee STA sent 60 GHz indicating to delete the link). The AP 110 may also instruct the STA how to reinitiate the 60 GHz link, such as to initiate charging of the device, to attempt reconnect on 60 Ghz link after period when heating levels are expected to have reduced to acceptable levels, and/or the like. Once the STA performs the instructions or otherwise is able to connect to the 60 GHz band again (e.g., the STA charged and/or cooled to an acceptable temperature), the STA may send a request (e.g., an Action Frame) to access the 60 GHz band.

An STA using the 60 GHz band may determine to stop using the 60 GHZ. For example, if battery levels and/or heating levels exceed thresholds due to 60 GHz operation, the STA may send a message to the AP 110 indicating 60 GHz operation is disfavored at present or the STA otherwise requests to disconnect from the 60 GHz band. Additionally, the message may indicate the importance of ceasing 60 GHZ operation (e.g., indicating that 60 GHz operation is somewhat disfavored, moderately disfavored, or heavily disfavored at present) based on the present conditions of the STA. In some examples, the STA may send the message to the AP 110 in response to crossing various threshold limits (e.g., five percent battery remaining, ten percent battery remaining, fifty percent battery remaining, five degrees from overheating, ten degrees from overheating, etc.). When the AP 110 receives the message, the AP 110 may then stop the 60 GHz operation of the STA. If the STA needs the 60 GHz operation to stop, the STA itself may also stop using the 60 GHz band without action by the AP 110.

The AP 110 may estimate channel conditions on the 60 GHz link provided by the third AP STA 118 by scheduling sounding and sensing frames over the 60 GHz link to its associated STAs that support 60 GHZ (e.g., the third STA 134 and the fourth STA 136). In some examples, the AP 110 may also send sounding and sensing frames to unassociated STAs that support 60 GHz. The AP 110 may then collect the results to estimate the channel conditions on the 60 GHz link. The results may include information such as Received Signal Strength Indicator (RSSI), Channel State Information (CSI), recommended Modulation Coding Scheme (MCS), and/or past successes and failures on DL and UL. Using the information, the AP 110 and/or STAs may determine if the 60 GHz link is a currently useful link, and, if the 60 GHz link is a currently useful link and if high throughput is required as indicated in a STA message (e.g., ASR, BSR) or as detected by the AP's traffic monitoring, then the AP 110 may enable 60 GHz data transmission with the STA.

In some embodiments, STAs may be capable of Joint Transmit (Tx). However, sounding overheads of Joint Tx may increase the energy consumption of the STA. The AP 110 and/or the STA may therefore restrict the use of Joint Tx in the 60 GHz band to reduce energy consumption when the STA has a clear Line-of-Sight channel to the AP 110.

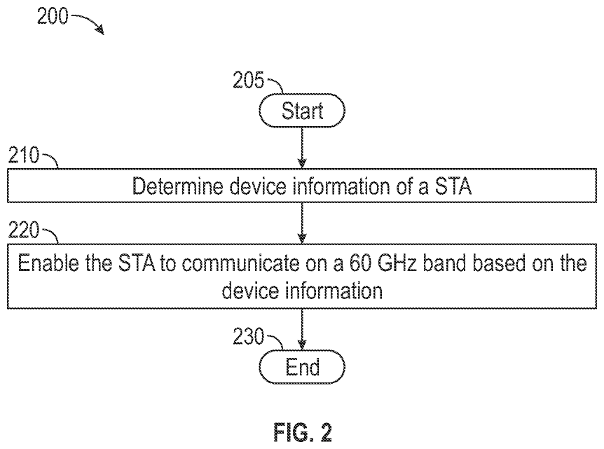

FIG. 2 is a block diagram of a method 200 for improving network throughput. The method 200 may begin at starting block 205 and proceed to operation 210. In operation 210, device information of a STA may be determined. For example, the AP 110 may determine the device information of the first STA 130, the second STA 132, the third STA 134, and/or the fourth STA 136. The STA may provide the device information in messages indicating a preference to use the 60 GHz band, periodic messages, and/or the like. The device information may include a battery level, a heat level, and/or a bandwidth requirement of upcoming communications.

In operation 220, the STA may be enabled to communicate on the 60 GHz band based on the device information. For example, the AP 110 may determine to enable the first STA 130, the second STA 132, the third STA 134, and/or the fourth STA 136 to communicate on the 60 GHz band (e.g., via the third AP STA 118). The AP 110 may determine to enable the STA to communicate on the 60 GHz band based on determining the battery level is above a battery level threshold, determining the heat level is below a heat level threshold, and/or determining the bandwidth requirement is above a bandwidth threshold.

The AP 110 may also monitor the device information (e.g., by receiving updates from the STA). When the battery level moves below a battery threshold, the heat level moves above a heat level threshold, and/or the bandwidth requirement moves below a bandwidth threshold, the AP 110 may disable the STA from communicating on the 60 GHz band or prioritize energy efficient transmissions for the STA as described above. The method 200 may conclude at ending block 230.

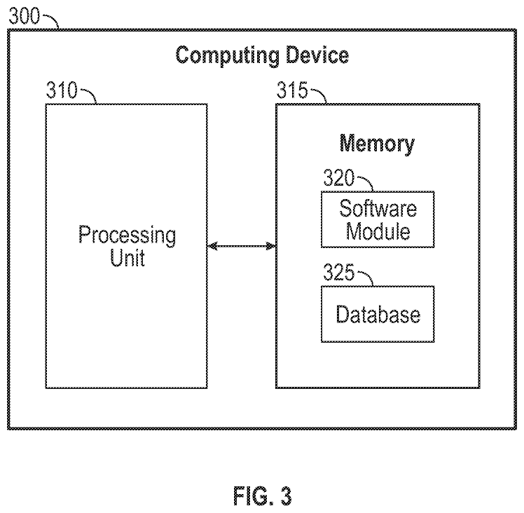

FIG. 3 is a block diagram of a computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for improving network throughput with respect to FIG. 1 and FIG. 2. Computing device 300, for example, may provide an operating environment for the controller 102, the AP 110, the first AP STA 114, the second AP STA 116, the third AP STA 118, the first STA 130, the second STA 132, the third STA 134, the fourth STA 136, and the like. The controller 102, the AP 110, the first AP STA 114, the second AP STA 116, the third AP STA 118, the first STA 130, the second STA 132, the third STA 134, the fourth STA 136, and the like may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining device information of a Station (STA); and
enabling the STA to communicate on a 60 Gigahertz (GHz) band based on the device information.

2. The method of claim 1, further comprising:
receiving a request from the STA to use the 60 GHz band for at least a portion of transmissions by the STA, wherein determining the device information is in response to the request.

3. The method of claim 2, wherein the request includes the device information.

4. The method of claim 1, wherein the device information comprises any one of: (i) a battery level, (ii) a heat level, (iii) a bandwidth requirement of an upcoming communication, or (iv) any combination (i)-(iii).

5. The method of claim 4, wherein enabling the STA to communicate on the 60 GHz band based on the device information comprises any one of: (i) determining the battery level is above a battery level threshold, (ii) determining the heat level is below a heat level threshold, (iii) determining the bandwidth requirement is above a bandwidth threshold, or (iv) any combination (i)-(iii).

6. The method of claim 4, further comprising:
monitoring the device information; and
when any one of (i) the battery level moves below a battery threshold, (ii) the heat level moves above a heat level threshold, (iii) the bandwidth requirement moves below a bandwidth threshold, or (iv) any combination of (i)-(iii):
disabling the STA from communicating on the 60 GHz band, or
prioritizing energy efficient transmissions for the STA.

7. The method of claim 1, further comprising:
receiving a request to cease 60 GHz band operation from the STA; and
disabling the STA from communicating on the 60 GHz band.

8. A system comprising:
a memory storage; and
a processing unit coupled to the memory storage, wherein the processing unit is operative to:
determine device information of a Station (STA); and
enable the STA to communicate on a 60 Gigahertz (GHz) band based on the device information.

9. The system of claim 8, the processing unit being further operative to:
receive a request from the STA to use the 60 GHz band for at least a portion of transmissions by the STA, wherein to determine the device information is in response to the request.

10. The system of claim 9, wherein the request includes the device information.

11. The system of claim 8, wherein the device information comprises any one of: (i) a battery level, (ii) a heat level, (iii) a bandwidth requirement of an upcoming communication, or (iv) any combination (i)-(iii).

12. The system of claim 11, wherein enabling the STA to communicate on the 60 GHz band based on the device information comprises any one of: (i) to determine the battery level is above a battery level threshold, (ii) to determine the heat level is below a heat level threshold, (iii) to determine the bandwidth requirement is above a bandwidth threshold, or (iv) any combination (i)-(iii).

13. The system of claim 11, the processing unit being further operative to:
monitor the device information; and
when any one of (i) the battery level moves below a battery threshold, (ii) the heat level moves above a heat level threshold, (iii) the bandwidth requirement moves below a bandwidth threshold, or (iv) any combination of (i)-(iii):
disable the STA from communicating on the 60 GHz band, or
prioritize energy efficient transmissions for the STA.

14. The system of claim 8, the processing unit being further operative to:
receive a request to cease 60 GHz band operation from the STA; and
disable the STA from communicating on the 60 GHz band.

15. A non-transitory computer-readable medium that stores a set of instructions which when executed perform a method executed by the set of instructions comprising:
determining device information of a Station (STA); and
enabling the STA to communicate on a 60 Gigahertz (GHz) band based on the device information.

16. The non-transitory computer-readable medium of claim 15, the method executed by the set of instructions further comprising:
receiving a request from the STA to use the 60 GHz band for at least a portion of transmissions by the STA, wherein determining the device information is in response to the request.

17. The non-transitory computer-readable medium of claim 16, wherein the request includes the device information.

18. The non-transitory computer-readable medium of claim 15, wherein the device information comprises any one of: (i) a battery level, (ii) a heat level, (iii) a bandwidth requirement of an upcoming communication, or (iv) any combination (i)-(iii).

19. The non-transitory computer-readable medium of claim 18, wherein enabling the STA to communicate on the 60 GHz band based on the device information comprises any one of: (i) determining the battery level is above a battery level threshold, (ii) determining the heat level is below a heat level threshold, (iii) determining the bandwidth requirement is above a bandwidth threshold, or (iv) any combination (i)-(iii).

20. The non-transitory computer-readable medium of claim 18, the method executed by the set of instructions further comprising:
monitoring the device information; and
when any one of (i) the battery level moves below a battery threshold, (ii) the heat level moves above a heat level threshold, (iii) the bandwidth requirement moves below a bandwidth threshold, or (iv) any combination of (i)-(iii):
disabling the STA from communicating on the 60 GHz band, or
prioritizing energy efficient transmissions for the STA.
